(19) United States
(12) Patent Application Publication
(10) Pub. No.: US 2005/0254508 A1
(43) Pub. Date: Nov. 17, 2005

(54) Cooperation between packetized data bit-rate adaptation and data packet re-transmission

(75) Inventors: Emre Baris Aksu, Tampere (FI); David Leon, Irving, TX (US); Igor Curcio, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/846,958

(22) Filed: May 13, 2004

(51) Int. Cl. H04L 12/26

(52) U.S. Cl. 370/428; 370/252; 714/748

(57) ABSTRACT

A method for improving a cooperation between a packetized data bit-rate adaptation and a data packet re-transmission transmits data packets from a server to a client with a first bit-rate; stores transmitted data packets in a server buffer; stores transmitted data packets in a client buffer; signals impairment information related to an impairment of transmitted data packets during transmitting to the server, wherein the signaled impairment information is analyzed by the server to decide if a re-transmission of data packets stored in the server buffer is required; and signals client buffer information related to a state of the client buffer to the server, wherein the client buffer information is analyzed by the server to decide if a re-transmission of data packets is required.

### FIELD OF THE INVENTION

This invention relates to methods, systems, clients, servers, computer programs and computer program products for improving a cooperation between a packetized data bit-rate adaptation and a data packet re-transmission.

### BACKGROUND OF THE INVENTION

Streaming, in a first aspect, refers to the ability of an application settled in a client to play back synchronized media streams like speech, audio and video streams in a continuous way while those streams are being transmitted to the client over a data network. In a second aspect, streaming also refers to real-time low-delay applications such as conversational applications.

Applications that can be built on top of streaming services can be classified into on-demand and live information delivery applications. Examples of the first category are music and news-on-demand applications. Live delivery of radio and television programs are examples of the second category. Real-time low delay application are, for example, multimedia (video)telephony or Voice over IP and any type of conversational multimedia application.

Streaming over fixed Internet Protocol (IP) networks is already a major application today. While the Internet Engineering Task Force (IETF) and the World Wide Web Consortium (W3C) have developed a set of protocols used in fixed-IP streaming services, no complete standardized streaming framework has yet been defined. For Third Generation (3G) mobile communications systems according to the standards developed by the Third Generation Partnership Project (3GPP), the 3G Packet-switched Streaming Service (PSS) fills the gap between the 3G Multi-media Messaging Service (MMS), for instance downloading applications and multimedia content, and conversational & streaming services. The PSS is described in detail in Technical Specification 3GPP TS 26.234 v0.3.0 “Transparent end-to-end Packet-Switched Streaming Service (PSS); Protocols and Codecs (Release 6) TSG-SA4 PSM SWG internal working draft”, denoted as TS 26.234 hereinafter.

The PSS enables mobile streaming applications, wherein the complexity of the terminals is lower than that required for conversational services, because no media input devices and encoders are required, and because less complex protocols can be used. The PSS includes a basic set of streaming control protocols, transport protocols, media codecs and scene description protocols.

FIG. 1 adopted from TS 26.234 schematically depicts the PSS protocol stack 1 that controls the transfer of both streamable and non-streamable content between a content or media server and a client.

Non-streamable content 106, as for instance multimedia content which is not created for streaming purposes (e.g. MMS clips recorded on a terminal device), still images, bitmap and vector graphics, text, timed text and synthetic audio are transferred by the Hypertext Transfer Protocol (HTTP) 107, which uses the services of the underlying Transport Control Protocol (TCP) 108 and the further underlying IP 105.

Streamable content 101, such as video, audio and speech, is first converted to the payload format of the Real-time Transport Protocol (RTP) 102 in an adaptation layer 103. Said RTP provides means for sending real-time or streaming data by using the services of an underlying User Datagram Protocol (UDP) 104, which in turn uses the services of an underlying IP protocol 105.

The RTP 102, which is specified in IETF Request for Comments (RFC) document 1889 “RTP: A Transport Protocol for Real-Time Applications”, provides end-to-end delivery services for data with real-time characteristics, such as interactive audio and video. Those services include payload type identification, sequence numbering, timestamping and delivery monitoring. RTP itself does not provide any mechanism to ensure timely delivery or provide other quality-of-service guarantees, but relies on lower-layer services to do so. It does not guarantee delivery or prevent out-of-order delivery, nor does it assume that the underlying network is reliable and delivers packets in sequence. The sequence numbers included in RTP allow the receiver to reconstruct the sender's packet sequence, but sequence numbers might also be used to determine the proper location of a packet, for example in video decoding, without necessarily decoding packets in sequence.

Closely linked to the RTP 102, which actually carries the data, is the RTP control protocol (RTCP), which monitors the quality of service and conveys information about the participants in an on-going session that is based on RTP. The RTCP is based on the periodic transmission of control packets to all participants in the session, using the same distribution mechanism as the data packets. RTCP provides feedback on the quality of the data transfer. This is an integral part of the RTP's role as a transport protocol and is related to the flow and congestion control functions of other transport protocols. The feedback may be directly useful to diagnose faults in the data transfer. The feedback function is performed by RTCP sender and receiver reports.

Based on the quality feedback provided by the RTCP, the PSS offers an RTP re-transmission scheme to mitigate quality degradation that is encountered when RTP packets are lost during transmission. Lost packets are indicated by RTCP-based quality feedback and are efficiently re-transmitted from the server to the client. This requires the server to store RTP packets that it has already sent up to some transmission depth, for instance, all RTP packets that were sent in the last 5 seconds have to be stored in RTP packet transmission buffers at the server to account for the case of their re-transmission.

Whereas for the non-streamable content 106, the built-in session set-up and control capabilities of the HTTP 107 are sufficient to transfer the content, in case of streamable content 101, an advanced session set-up and control protocol has to be invoked, for instance to start, stop and pause a streaming video that is transferred from the content server to the client via the RTP/UDP/IP. This task is performed by the Real-time Streaming Protocol (RTSP) 109, which may either use the underlying TCP 108 or the underlying UDP 104. RTSP requires a presentation description 110 at least to set-up a streaming session. Such a presentation description 110 may for instance be available in the form of a Session Description Protocol (SDP) file. Said SDP file contains the description of the session, for instance session name and author, the type of media to be presented, information to receive said media, as for instance addresses, ports, formats and so on, and the bit-rate of the media.

The PSS includes a number of protocols and functionalities that can be utilized to allow the PSS session to adapt transmission and content rates (e.g. bit rates) to the available network resources. The goal of this rate adaptation is of course to achieve highest possible quality of experience for the end-user with the available resources, while maintaining interrupt-free playback of the media. Rate adaptation requires that the available network resources are estimated and that transmission rates are adapted to the available network link rates. This can prevent overflowing network buffers and thereby avoid packet losses. The real-time properties of the transmitted media must be considered so that media does not arrive too late to be useful. This will require that media content rate (i.e the bit-rate of the content) is adapted to the transmission rate.

To avoid buffer overflows, resulting in that the client must discard useful data, while still allowing the server to deliver as much data as possible into the client buffer, a functionality for client buffer feedback is defined in the scope of the PSS. This allows the server to closely monitor the buffering situation on the client side and to do what it is capable in order to avoid client buffer underflow. The client specifies how much buffer space the server can utilize and the desired target level of protection. When the desired level of protection is achieved, the server may utilize any resources beyond what is needed to maintain that protection level to increase the quality of the media. The server can also utilize the buffer feedback information to decide if the media quality needs to be lowered in order to avoid a buffer underflow and the resulting play-back interruption. For the server, one way of performing rate adaptation is to keep multiple encoded versions of the same content, wherein the encoding bit-rate serves as the differentiation criterion. Rate adaptation then may be performed by switching between the differently encoded content in dependence on the state of the client buffer.

The rate adaptation for PSS is server-centric in the meaning that transmission and content rate are controlled by the server. The server uses RTCP and RTSP as the basic information sources about the state of the client and network.

To allow for rate adaptation in the PSS, client buffer feedback signaling functionality should be supported by PSS clients and PSS servers. For PSS clients and servers that support the client buffer feedback signaling functionality, at least the following parts should be implemented:
Signaling of the size (e.g. in bytes) of the buffer the client provides for rate adaptation to the server through the RTSP.
Signaling of the sequence number of the oldest (“oldest buffered sequence number”, OBSN) packet in the client buffer to the server via the RTCP. The OBSN information may for instance be sent from the client to the server in RTCP application (APP) packets.

With the buffer size, the OBSN parameters, and by means of the “Highest Received Sequence Number” HRSN already contained in RTCP receiver reports, the server can calculate the number of bytes in the client buffer at the sending time of the last received RTCP report.

Based on the calculated client buffer fill level, the server can avoid overflowing the buffer. This level will also allow the server to detect when the buffer level drops and thus react to try to prevent underflow. The time before the client buffer will underflow can be estimated by the server by referring to the timestamp of the packet of highest sequence number, the timestamp of the packet of oldest sequence number and the playout delay of the packet of oldest sequence number, if signaled. The playout delay improves the accuracy of the estimated time before the client underflows. For example, in the case of low frame-rate video, the playout delay may contribute significantly to the total buffering time at the client.

However, the combination of the rate adaptation functionality and the RTP re-transmission functionality in the PSS causes problems.

First, when the server performs rate adaptation by changing the bit-rate of the packet stream that is transferred to a client based on the feedback received from this client, the server flushes its transmission buffers. Such a flushing operation severely interferes or even disables the proper functioning of the RTP re-transmission scheme, which is based on the storage of already transmitted RTP packets for a certain transmission depth to account for the case of a possible future re-transmission of RTP packets due to RTP packet loss. For instance, if re-transmission of an RTP packet is required that is no longer available at said server due to said flushing, said server may have to get hold of said RTP packet again (e.g. via re-iterating through the hint tracks in a server-side 3GP file to find the appropriate RTP packet), which causes additional delay, or may no longer be possible at all. Said delay or said lack of said RTP packet directly impacts the application running on top of said RTP, for instance a playback of an associated streaming media may be frozen or even stalled.

A further problem arises when the OBSN reported by the client in the context of rate adaptation (for instance via RTCP APP packets) is larger than or very close to the sequence number of an RTP packet that is requested for re-transmission in the context of RTP re-transmission. The RTP packet identified by said reported OBSN is the first RTP packet to be removed by the client from the RTP packet buffer for decoding purposes (e.g. to be put to the post-decoder buffer for waiting to be displayed). Thus any re-transmission of an RTP packet with a sequence number being smaller than the reported OBSN would be unnecessary and thus a waste of bandwidth.

### SUMMARY OF THE INVENTION

In view of the above-mentioned problems, it is, inter alia, an object of the present invention to provide methods, systems, clients, servers, computer programs and computer program products for improving a cooperation between a packetized data bit-rate adaptation and a data packet re-transmission.

According to a first aspect of the present invention, a method for improving a cooperation between a packetized data bit-rate adaptation and a data packet re-transmission is proposed, comprising transmitting data packets from a server to a client with a first bit-rate; at least temporarily storing at least one of said transmitted data packets in at least one server buffer; at least temporarily storing at least one of said transmitted data packets in a client buffer; signaling impairment information related to an impairment of at least one of said transmitted data packets during said transmitting to said server, wherein said signaled impairment information is analyzed by said server to decide if a re-transmission of at least one data packet stored in said server buffer from said server to said client is required; signaling client buffer information related to a state of said client buffer to said server; transmitting data packets from said server to said client with a second bit-rate, wherein said second bit-rate is at least partially determined based on said client buffer information, and wherein at least one data packet transmitted with said first bit-rate and stored in said server buffer is further stored in said server buffer when said transmitting of said data packets from said server to said client with said second bit-rate starts.

Said data packets may represent logical or physical units of a data stream that is composed of information-carrying symbols, for instance data bits or modulated representations thereof. For instance, said data stream may be a media stream transmitted from said server to said client in a streaming session that is at least partially based on a Real-time Transport Protocol RTP, and, correspondingly, said server then may be a content or streaming media server, said client may be a streaming client, and said data packets may be RTP packets. Said streaming may then be performed in uni-cast or multi-cast mode. In a more general sense, said server and client may also be understood as transmitter and receiver in a data transmission system. Said transmission of said data packets may be a physical or logical transmission that is provided and/or controlled by protocols. The physical transmission medium may either be wireless or wire-bound, or may be composed of both wireless and wire-bound segments. Said transmitting of said data packets is performed with a first bit-rate, which may refer to the logical or physical transmitting. For instance, that bit-rate may be determined by the amount of source and/or channel coding performed on the content of said data packets, or by the number and/or transmission capacity of transmission channels or bearers used for the transmission of said data packets.

At said server, at least one data packet transmitted to said client is at least temporarily stored in a server buffer. This buffer represents a re-transmission buffer, from which data packets that are not correctly received at the client may be transmitted anew, for instance under the control of an Automatic Repeat Request ARQ protocol or based on the services of a Real-time Transport Control Protocol RTCP. Said storage of said at least one data packet in said server buffer may be time-limited, so that said at least one packet is removed from said server buffer after a pre-defined or dynamically adapted time.

At said client, at least one data packet transmitted to and received at said client is at least temporarily stored in said client buffer. From said client buffer, stored data packets may be lead to further processing in said client, for instance, said data packets from said client buffer may be played back by an application. Said client buffer may serve as a compensation buffer that allows the rate with which data packets arrive at said client buffer to vary due to the transmission characteristics (e.g. delay, loss) of the physical and logical transmission medium between the server and the client.

Said client signals impairment information to said server, wherein said impairment information is related to an impairment of at least one data packet during its transmission from said server to said client. For instance, said impairment may denote the loss or corruption of one or several data packets. An example of impairment information may be the signaling of an identification, for instance a sequence number, of the last data packet that was received correctly. Said data-packet-transmitting server may derive from said impairment information, in particular if a pre-defined time has passed, that one or several packets have not been received correctly at said receiver, and may then attempt to re-transmit data packets. Said signaling may be performed based on a protocol, for instance a Real-time Transport Control Protocol. Based on said impairment information, said server may determine if a re-transmission of already transmitted, but corrupted or lost data packets is required, which then may be fetched from said server buffer and transmitted to said client anew.

Said client further signals client buffer information to said server, which is related to a state of said client buffer. This client buffer information may for instance refer to the space left in the client buffer, or may represent a sequence number of a specific data packet stored in said client buffer, in particular the sequence number of the oldest data packet stored in said client buffer, i.e. the data packet that not yet has been read out from said client buffer for further processing and the storage time of which is the largest among all data packets stored in said client buffer. Correspondingly, said oldest data packet is the next data packet to be read out from said client buffer for further processing.

Based on said signaled client buffer information, said server changes said first bit-rate to a second bit-rate. This packetized data bit-rate adaptation step may for instance be required to avoid an overflow or underflow of said client buffer, and may require a change of the amount of source and/or channel coding performed on the content of said data packets, and/or a change of the number and/or transmission capacity of transmission channels or bearers used for the transmission of said data packets.

According to the first aspect of the present invention, at least one data packet transmitted with said first bit-rate and stored in said server buffer is further stored in said server buffer when said transmitting of said data packets from said server to said client with said second bit-rate starts. Thus when the bit-rate is changed, the server buffer, which contains data packets transmitted with the first bit-rate, is not flushed as in prior art systems. In contrast, the stored data packets transmitted with the first bit-rate are maintained in said server buffer, and are for instance deleted from said server buffer only after a time duration that may depend on the signaled impairment information. This allows the data packet re-transmission, as far as it is required for data packets that were transmitted with the first bit-rate; to be successfully completed, even when the transmitting of data packets with the second bit-rate already has started. In contrast to prior art, according to the present invention, the case that a corrupted or lost data packet transmitted with the first bit-rate is not available for re-transmission in the server buffer due to a flushing of said server buffer at the instance of a packetized data bit-rate adaptation from a first to a second bit-rate can no longer occur, thus avoiding delay or break-down of applications fed by said data packets.

According to a preferred embodiment of the first aspect of the present invention, said at least one data packet transmitted with said first bit-rate and stored in said server buffer is stored in said server buffer for a time duration that is determined by said server based on said signaled impairment information. This may be accomplished by assigning the data packets in said server buffer an expiration time.

According to a preferred embodiment of the first aspect of the present invention, the removal of said at least one data packet transmitted with said first bit-rate and stored in said server buffer from said server buffer depends on said signaled client buffer information. Said at least one data packet may for instance be deleted from said at server buffer if it is determined from said client buffer information that a re-transmission of said data packet is no longer necessary or useful.

According to a preferred embodiment of the first aspect of the present invention, said client buffer information refers to an identification of the oldest data packet stored in said client buffer. Said term old is to be understood to be related to the time instance when said data packet was stored in the client buffer. Said identification may for instance be a sequence number of said oldest data packet.

According to a preferred embodiment of the first aspect of the present invention, said transmitting of said data packets from said server to said client is at least partially based on a Real-time Transport Protocol RTP, and wherein said signaling of said impairment information and said client buffer information is at least partially based on a Real-time Transport Control Protocol RTCP. Said data packets then are RTP packets, and said client buffer information, for instance the Oldest Buffered Sequence Number OBSN may be signaled by using RTCP application APP packets.

According to a preferred embodiment of the first aspect of the present invention, said data packets are associated with a media stream that is transmitted from said server to said client according to a 3GPP Packet-Switched Streaming Service PSS.

According to a first aspect of the present invention, furthermore a system, a client and a server for improving a cooperation between a packetized data bit-rate adaptation and a data packet re-transmission are further proposed.

According to a second aspect of the present invention, a method for improving a cooperation between a packetized data bit-rate adaptation and a data packet re-transmission is further proposed, comprising transmitting data packets from a server to a client with a first bit-rate; at least temporarily storing at least one of said transmitted data packets in at least one server buffer; at least temporarily storing at least one of said transmitted data packets in a client buffer; signaling impairment information related to an impairment of at least one of said transmitted data packets during said transmitting to said server; signaling client buffer information related to a state of said client buffer to said server, wherein said signaled client buffer information is analyzed by said server to change said first bit-rate of said transmitting of said data packets to a second bit-rate; deciding, based on said signaled impairment information and said signaled client buffer state information, if a data packet re-transmission is required; and only re-transmitting at least one data packet stored in said server buffer from said server to said client, if it is decided that a data packet re-transmission is required.

Said data packets may represent logical or physical units of a data stream that is composed of information-carrying symbols, for instance data bits or modulated representations thereof. For instance, said data stream may be a media stream transmitted from said server to said client in a streaming session that is at least partially based on a Real-time Transport Protocol RTP, and, correspondingly, said server then may be a content or streaming media server, said client may be a streaming client, and said data packets may be RTP packets. Said streaming may then be performed in uni-cast or multi-cast mode. In a more general sense, said server and client may also be understood to be a transmitter and receiver in a data transmission system. Said transmission of said data packets may be a physical or logical transmission that is provided and/or controlled by protocols. The physical transmission medium may either be wireless or wire-bound, or may be composed of both wireless and wire-bound segments. Said transmitting of said data packets is performed with a first bit-rate, which may refer to the logical or physical transmitting. For instance, that bit-rate may be determined by the amount of source and/or channel coding performed on the content of said data packets, or by the number and/or transmission capacity of transmission channels or bearers used for the transmission of said data packets.

At said server, at least one data packet transmitted to said client is at least temporarily stored in a server buffer. This buffer represents a re-transmission buffer, from which data packets that are not correctly received at the client may be transmitted anew, for instance under the control of an Automatic Repeat Request ARQ protocol or based on the services of a Real-time Transport Control Protocol RTCP. Said storage of said at least one data packet in said server buffer may be time-limited, so that said at least one packet is removed from said server buffer after a pre-defined or dynamically adapted time.

At said client, at least one data packet transmitted to and received at said client is at least temporarily stored in said client buffer. From said client buffer, stored data packets may be lead to further processing in said client, for instance, said data packets from said client buffer may be played back by an application. Said client buffer may serve as a compensation buffer that allows the rate with which data packets arrive at said client buffer to vary due to the transmission characteristics (e.g. delay, loss) of the physical and logical transmission medium between the server and the client.

Said client signals impairment information to said server, wherein said impairment information is related to an impairment of at least one packet during its transmitting from said server to said client. For instance, said impairment may denote the loss or corruption of one or several data packets. For instance, said impairment may denote the loss or corruption of one or several data packets. An example of impairment information may be the signaling of an identification, for instance a sequence number of the last data packet that was received correctly. Said data-packet-transmitting server may derive from said impairment information, in particular if a pre-defined time has passed, that one or several packets have not been received correctly at said receiver, and may then attempt to re-transmit data packets. Said signaling may be performed based on a protocol, for instance a Real-time Transport Control Protocol RTCP.

Said client further signals client buffer information to said server, which is related to a state of said client buffer. This client buffer information may for instance refer to the space left in the client buffer, or may represent a sequence number of a specific data packet stored in said client buffer, in particular the sequence number of the oldest data packet stored in said client buffer, i.e. the data packet that not yet has been read out from said client buffer for further processing and the storage time of which is the largest among all data packets stored in said client buffer. Correspondingly, said oldest data packet is the next data packet to be read out from said client buffer for further processing.

Based on said signaled client buffer information, said server may change said first bit-rate to a second bit-rate. This packetized data bit-rate adaptation step may for instance be required to avoid an overflow or underflow of said client buffer, and may require a change of the amount of source and/or channel coding performed on the content of said data packets, and/or a change of the number and/or transmission capacity of transmission channels or bearers used for the transmission of said data packets.

According to the second aspect of the present invention, a re-transmission of at least one data packet stored in said server buffer from said server to said client is only performed if it is decided that a data packet re-transmission is required, wherein this decision is based on said signaled impairment information and said signaled client buffer state information. In contrast to prior art, wherein the decision on a re-transmission is only based on the signaled impairment information, thus according to the second aspect of the present invention, also the signaled client buffer information is considered in this decision. If for instance said impairment information indicates that a certain data packets needs re-transmission, said client buffer information may nevertheless indicate that this specific data packet does not require re-transmission, for instance because it is already stored in said client buffer, or has already been stored and further processed some time before, or will, even in case of successful re-transmission, arrive at said client to late to be of worth. Thus according to the second aspect of the present invention, unnecessary re-transmissions of data packets occurring in prior art systems that combine data packet re-transmission and packetized data bit-rate adaptation can be completely avoided.

According to a preferred embodiment of the second aspect of the present invention, said impairment information allows to determine a sequence number of at least one data packet impaired during said transmitting, and wherein said client buffer information refers to a sequence number of the oldest data packet stored in said client buffer, and wherein said deciding if a data packet re-transmission is required depends on a difference between said sequence-number of said at least one impaired data packet and said oldest data packet. Unnecessary re-transmissions thus may for instance be avoided by demanding that only data packets younger than said oldest data packet are re-transmitted, which, for sequence numbers of data packets increasing with time, leads to the demand that said difference between said sequence number of said impaired data packet and said oldest data packet has to be larger than zero for a re-transmission of said impaired data packet.

According to a preferred embodiment of the second aspect of the present invention, data packets stored in said server buffer are deleted depending on a difference between their associated sequence numbers and said sequence number of said oldest data packet. It may for instance be advantageous to remove all data packets which have a smaller sequence number than said oldest data packet, i.e. are older than said oldest data packet in said client buffer. Said data packets then are deleted if said difference is smaller than zero.

According to a preferred embodiment of the second aspect of the present invention, said transmitting of said data packets from said server to said client is at least partially based on a Real-time Transport Protocol RTP, and wherein said signaling of said impairment information and said client buffer information is at least partially based on a Real-time Transport Control Protocol RTCP. Said data packets then are RTP packets, and said client buffer information, for instance the Oldest Buffered Sequence Number OBSN, may be signaled by using RTCP application APP packets.

According to a preferred embodiment of the second aspect of the present invention, said data packets are associated with a media stream that is transmitted from said server to said client according to a 3GPP Packet-Switched Streaming Service PSS.

According to a second aspect of the present invention, furthermore a system, a client and a server for improving a cooperation between a packetized data bit-rate adaptation and a data packet re-transmission are further proposed.

According to the present invention, a computer program is further proposed with instructions operable to cause a processor to perform any of the above-mentioned method steps.

A computer program product is further proposed comprising a computer program with instructions operable to cause a processor to perform any of the above-mentioned method steps.

These and other aspects of the invention will be apparent from and elucidated with reference to the embodiments described hereinafter.

### BRIEF DESCRIPTION OF THE FIGURES

In the figures show:

FIG. 1: A schematic representation of a Packet-Switched Streaming Service (PSS) protocol stack according to the prior art;

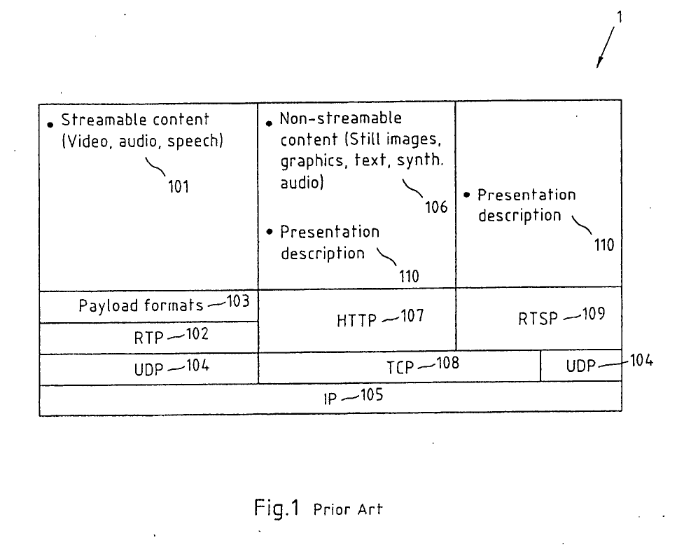

FIG. 2: the basic components of an exemplary system for improving a cooperation between a packetized data bit-rate adaptation and a data packet re-transmission according to the present invention;

FIG. 3: an exemplary flowchart of the method steps performed at a server for improving a cooperation between a packetized data bit-rate adaptation and a data packet re-transmission according to the present invention; and

FIG. 4: an exemplary flowchart of the method steps performed at a client for improving a cooperation between a packetized data bit-rate adaptation and a data packet re-transmission according to the present invention.

### DETAILED DESCRIPTION OF THE INVENTION

The present invention proposes to improve a cooperation between a packetized data bit-rate adaptation and a data packet re-transmission by demanding that a server does not flush its re-transmission buffers when changing a packetized data bit-rate, and that data packets are only re-transmitted if a client buffer information fed back from the client indicates that this re-transmitted packet is actually required. In the following, exemplary embodiments of the present invention will be presented in the context of the Third Generation Partnership Project (3GPP) Packet-Switched Streaming Service (PSS). It should however be noted that the present invention is by no means restricted to an application in the PSS, it may equally well be deployed in all kinds of communication systems where a packetized data bit-rate adaptation and a data packet re-transmission is jointly implemented.

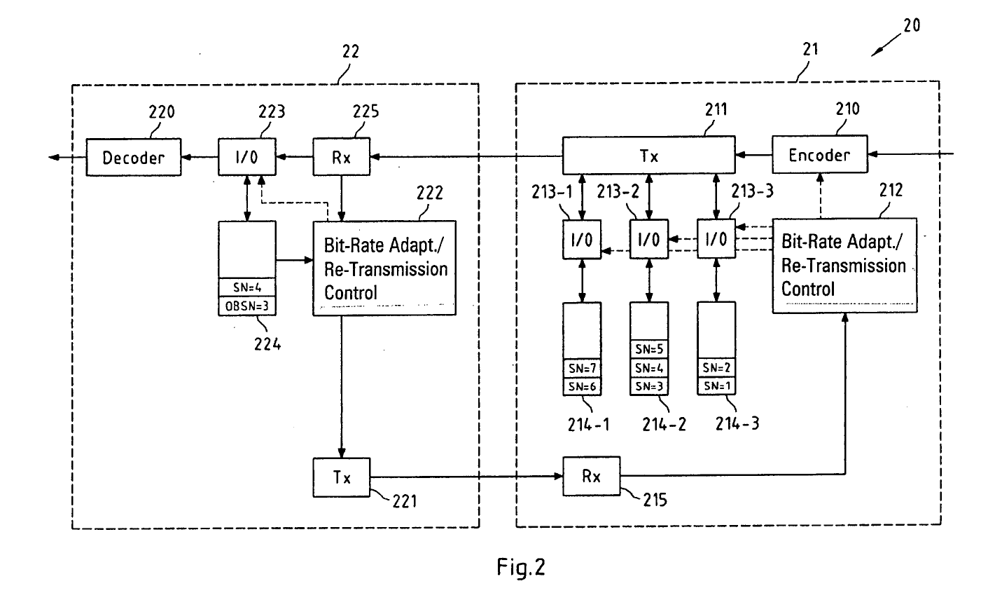

FIG. 2 depicts the basic components of an exemplary system 20 for improving a cooperation between a packetized data bit-rate adaptation and a data packet re-transmission according to the present invention. The system comprises a server 21 and a client 22, wherein RTP data packets are streamed from said server 21 to said client 22 in a streaming session. An example of such a streaming session may for instance be the download of a video from an internet server to a mobile phone, wherein said video stream is played back on said mobile phone simultaneously with the download process.

Said server 21 receives a data stream, for instance from a content server or from any other kind of storage medium, which may equally well be located in said server 21 as well, and encodes said data stream into a sequence of Real-time Transport Protocol (RTP) packets in an encoder instance 210. This encoding may for instance comprise switching between data streams, e.g. bit-streams, with different bit-rates. The RTP packets are then forwarded into a transmission instance 211, which performs the transmission of said RTP packets to a receiver instance 225 in said client 22 over a transmission channel. This transmission is to be understood logically, i.e. the RTP data packets are actually transmitted by handing them to lower protocol layers that perform the physical transmission between server 21 and client 22. Said transmission instance 211 thus may for instance represent an RTP entity communicating with a peer entity 225 in said client 22. The transmitted RTP packets are stored by transmission instance 211 in bit-rate-specific re-transmission buffers 214-1 . . . 214-3, which are made accessible to the transmission instance 211 via input/output (I/O) interfaces 213-1 . . . 213-3, respectively. In the present example of FIG. 2, three different bit-rates are supported, and actually seven data packets identified by their Sequence Numbers (SN) have been transmitted from said server 21 to said client 22 and correspondingly stored in said bit-rate-specific re-transmission buffers 214-1 . . . 214-3. RTP packets SN=1 and SN=2 have been transmitted with the highest bit-rate and stored in re-transmission buffer 214-3. Then a change of the bit-rate occurred from said highest bit-rate to a lower bit-rate, at which RTP packets SN=3, SN=4, and SN=5 were transmitted and stored in re-transmission buffer 214-2. After a further change to an even lower bit-rate, RTP packets SN=6 and SN=7 were transmitted and stored in re-transmission buffer 214-1. Said changes in said bit-rate are initiated by a bit-rate adaptation/re-transmission control instance 212 in response to the client buffer information, in the present example the Oldest Buffered Sequence Number (OBSN) signaled from the client 22 in RTCP APP packets. Based on this OBSN, the client buffer size (e.g., signaled during session establishment) and the Highest Received Sequence Number (HRSN, signaled in RTCP receiver reports), the bit-rate adaptation/re-transmission control instance 212 remotely controls the client buffer 224 so that over- and/or underflow is avoided. Said bit-rate adaptation/re-transmission control instance 212 controls said encoder 210 in order to change the bit-rate, for instance by instructing the encoder to switch between different bit-streams with different bit-rates, respectively. Said bit-rate adaptation/re-transmission control instance 212 further controls said I/O interfaces 213-1 . . . 213-3 to ensure that the RTP packets with the different bit-rates are stored in the correct re-transmission buffers 214-1 . . . 214-3. Furthermore, if a re-transmission of RTP packets stored in said re-transmission buffers 214-1 . . . 214-3 is required, which is determined by said bit-rate adaptation/re-transmission control instance 212 in response to impairment information from said client 22, said bit-rate adaptation/re-transmission control instance 212 also controls the transfer of the corresponding RTP packets from the re-transmission buffers 214-1 . . . 214-3 to the transmission instance 211. Said impairment information, which, according to the present example, is information on lost RTP packets, is received from said client 225 by a reception instance 215, similar to said client buffer information. As said transmission instance 211, also said reception instance 215 is to be understood logically, i.e. the client buffer information and the impairment information may for instance be signaled via the RTCP, and said reception instance 215 then represents an RTCP entity communicating with a peer entity 221 in said client 22.

Said client 22 receives the RTP packets transmitted from said server 21 via a reception instance 225, which may for instance be an RTP entity. In said entity 225, it is checked if the RTP packets are impaired (e.g. corrupted) or not, for instance by a simple checksum. If said RTP packets are not impaired, they are stored in a client buffer 224 via an I/O interface 223. A bit-rate adaptation/re-transmission control instance 222 in said client 22 receives information on impaired RTP packets from said reception instance 225, for instance a SN of the last data packet received correctly, and client buffer state information from said client buffer 224, for instance the actual values of HRSN and OBSN. Said bit-rate adaptation/re-transmission control instance 222 triggers the feed-back of said impairment information and said client buffer information to said server 21 via a transmission instance 221, which may again be understood as a protocol entity. Furthermore, said bit-rate adaptation/re-transmission control instance 222 may control the I/O interface 223 to trigger the forwarding of RTP packets from said client buffer 224 to a decoder instance 220, in which the RTP packets are decoded back to data streams (e.g. bit-streams) with different bit-rates. In the present example, the OBSN in said client buffer is OBSN=3, and said client buffer further contains RTP packet SN=4. RTP packets SN=1 and SN=2 thus have already been received, stored in said client buffer 224, read out from said client buffer 224 and decoded by said decoder 220 for playback. However, RTP packets SN=5, SN=6 and SN=7 are not yet stored in said client buffer 224, although they already were transmitted by server 21, as indicated by their storage in re-transmission buffer 214-1.

Consider now the case that RTP packet SN=5 was corrupted or lost during the transfer from server 21 to client 22. Information related to this corruption or loss is signaled to the bit-rate adaptation/re-transmission control instance 212 of the server 21 by said bit-rate adaptation/re-transmission control instance 222 of the client 22, in order to cause a re-transmission of RTP packet SN=5. A re-transmission of this RTP packet SN=5 requires that this RTP packet SN=5 is still stored in one of the re-transmission buffers 214-1 . . . 214-3. However, note that RTP packets SN=3, SN=4 and SN=5 were transmitted with a medium bit-rate, and that after their transmission, a change to an even lower bit-rate occurred for the transmission of RTP packets SN=6 and SN=7. According to prior art, such a change generally causes re-transmission buffers 214-1 . . . 214-3 to be flushed, i.e. all RTP packets stored therein are instantaneously deleted. This prior art approach causes problems in the present case, because with the flushing of all re-transmission buffers 214-1 . . . 214-3, also re-transmission buffer 214-2 that contained RTP packet SN=5, now required for re-transmission, would be flushed, leading either to a denial of the server 21 to re-transmit this RTP packet or to a delay until the server can get hold of this RTP packet from a content source again, which may incorporate new encoding, etc. Thus the present invention, according to its first aspect, demands that the re-transmission buffers 214-1 . . . 214-3 are not instantaneously flushed when a bit-rate is changed, but have to further keep their RTP packets. Thus according to the present invention, RTP packet SN=5 will be contained in re-transmission buffer 214-2 although the bit-rate with which RTP packet SN=5 was transmitted has been changed to the bit-rate with which RTP packets SN=6 and SN=7 were transmitted.

The first aspect of the present invention thus improves the cooperation of bit-rate adaptation and re-transmission. It is easily implemented at the server site and may not require changes at the client site. Depending on the level of optimality of the system, it may be demanded that the server must not, or should not flush its re-transmission buffers after a change of bit-rate. After an expiration date of RTP packets, which may for instance be derived from RTCP feedback reports or from an OBSN, the server then may be allowed to remove single RTP packets from its re-transmission buffers 214-1 . . . 214-3.

Consider now the case that RTP packet SN=3 was corrupted during the transmission. In a prior art system, this would trigger the re-transmission of RTP packet SN=3 (assuming that RTP packet SN=3 is still stored in the server's re-transmission buffers 214-1 . . . 214-3, which, irrespective of the fact whether the first aspect of the invention is applied in the server 21 or not, would be the case when for instance assuming that after the transmission of RTP packets SN=3, SN=4 and SN=5, no change in bit-rate occurred that might have caused a flushing of re-transmission buffer 214-2). However, according to the OBSN=3 of the client buffer 224, which indicates that RTP packet SN=3 is already correctly stored in the client buffer 224, a re-transmission of RTP packet SN=3 is actually not required. This situation may for instance occur if, due to inevitable delays in the feed-back of impairment information and the re-transmission of RTP packets and resulting time-outs, correct and corrupted versions of RTP packet SN=3 are received at client 22 at different time instances. In a different example, the OBSN may indicate that the difference in sequence numbers between the OBSN, which will be processed (e.g., played) next in client 22, and the SN of the RTP packet which is to be re-transmitted is too small, so that even when said RTP packet is re-transmitted successfully, its reception at the client 22 will be too late.

In prior art, information on the OBSN is only considered for bit-rate adaptation, and not for re-transmission. Thus according to a second aspect of the present invention, it is proposed that both the impairment information (on corrupted RTP packets) and the client buffer information (on the OBSN) are considered before re-transmitting an RTP packet.

This second aspect of the present invention thus also improves the cooperation of bit-rate adaptation and re-transmission. It is also easily implemented at the server site and may not require changes at the client site. Depending on the level of optimality of the system, it may be demanded that the server must not, or should not re-transmit packets if it is aware that packets demanded to be re-transmitted by the client are already contained in the client buffer 224 or will arrive at the client too late to be of any worth for the client. The OBSN may further be used by the server to remove RTP packets that have SNs being smaller or equal to the OBSN from its re-transmission buffers 214-1 . . . 214-3, which is of particular advantage when the first aspect of the present invention is implemented in the server as well.

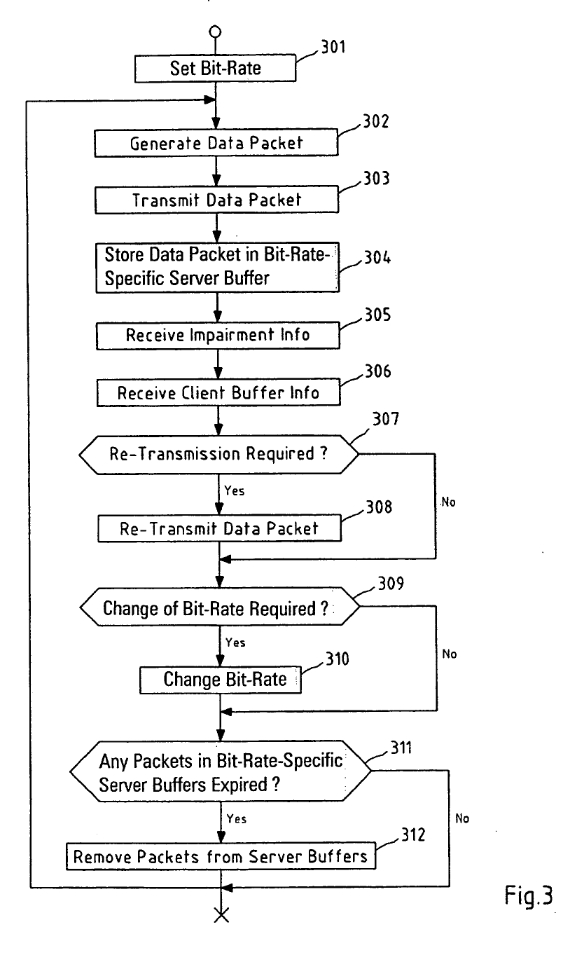

FIG. 3 represents an exemplary flowchart of the method steps performed at a server for improving a cooperation between a packetized data bit-rate adaptation and a data packet re-transmission according to the present invention. In a first step 301, a bit-rate at the server is set. This bit-rate may for instance be a bit-rate of a bit-stream that is to be transmitted from the server to a client, for instance via the RTP. This bit-rate may for instance be a default value prescribed for said transmission, which can be further refined during transmission, based on feed-back from said client, in order to ensure that no buffer over- or underflow occurs in the client's buffer. In a second step 302, then data packets, for instance RTP packets, are generated from said bit-stream, and transmitted to said client in a step 303. Transmitted data packets are stored in bit-rate-specific server buffers (re-transmission buffers) according to said set bit-rate in a step 304. Impairment information, for instance the SN of a corrupted data packet that is to be re-transmitted, or the SN of the last data packet that was received correctly at said client, is transmitted from said client, for instance via the RTCP, and received at said server in a step 305. Similarly, client buffer information, for instance an OBSN, is received at said server in a step 306. Based on both said impairment and client buffer information, it is then decided in a step 307, if a re-transmission of data packets is actually required or not. If this is found to be true, the re-transmission of data packets is performed in step 308. If this is not the case, or after the re-transmission, it is checked in a step 309 if a change of the bit-rate is required. This is determined at least partially based on the client buffer information received in step 306, for instance an OBSN, and then further information on the client buffer size and the HRSN may be exploited for said check. If it is determined that a change of the bit-rate is required to avoid an over- or underflow of the client's buffer, the bit-rate is changed in a step 310. After this step, or if it is determined that no change is required, it is further checked in a step 311 if any packets may be removed from the bit-rate-specific server buffer, for instance because their expiration time is over or because the client buffer information received in step 306 indicates that a re-transmission of these data packets is no longer useful. If data packets are decided to be removed, this removal is performed in step 312. After this, or if no removal takes place, the method jumps back to step 302 and generates further data packets to be transmitted to the client.

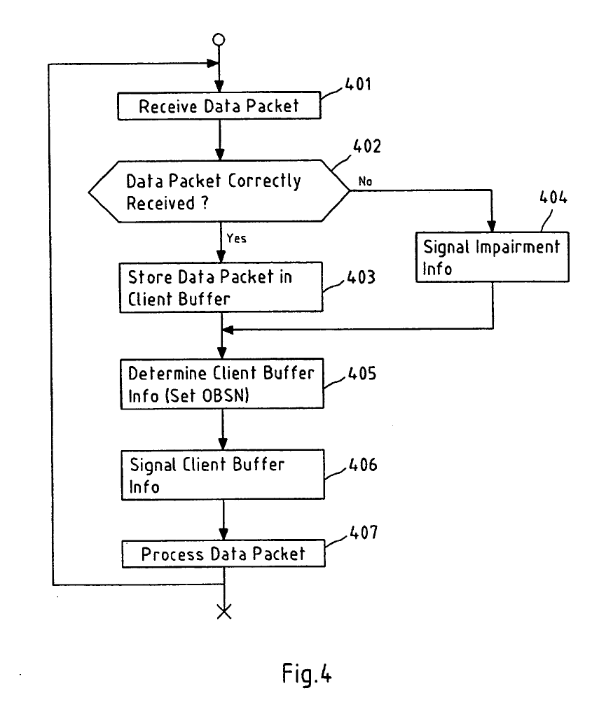

FIG. 4 represents an exemplary flowchart of the method steps performed at a client for improving a cooperation between a packetized data bit-rate adaptation and a data packet re-transmission according to the present invention. In a first step 401, data packets, for instance RTP packets, are received at the client. In a step 402, it is checked if the data packets were received correctly or are corrupted or were lost, for instance by processing a checksum or other error detection code or checking whether there is any missing SN in the received sequence of packets. If correct reception is determined, the data packets are stored in a client buffer in a step 403. Otherwise, impairment information is signaled to the server that sent the data packets in a step 404. Alternatively, impairment information, such as the SN of the last data packet that was received correctly at said client, may be signaled to said server regardless whether the data packet was determined to be received correctly in step 402 or not. In a step 405, then client buffer information, as for instance an OBSN, is determined from the client buffer, and signaled to the server in a step 406. Then, in a step 407, the data packets are further processed, for instance by fetching them from the client buffer, and decoding or playing them back. Finally, the method jumps back to step 401, wherein further data packets are received.

The present invention has been described above by means of preferred embodiments. It should be noted that there are alternative ways and variations which are obvious to a skilled person in the art and can be implemented without deviating from the scope and spirit of the appended claims. In particular, the present invention is not restricted to deployment in the 3GPP PSS, it may equally well be deployed in all types of wireless and/or wire-bound communication systems that use bit-rate adaptation and re-transmission.

1. A method for improving a cooperation between a packetized data bit-rate adaptation and a data packet re-transmission, comprising:
transmitting data packets from a server to a client with a first bit-rate;
at least temporarily storing at least one of said transmitted data packets in at least one server buffer;
at least temporarily storing at least one of said transmitted data packets in a client buffer;
signaling impairment information related to an impairment of at least one of said transmitted data packets during said transmitting to said server, wherein said signaled impairment information is analyzed by said server to decide if a re-transmission of at least one data packet stored in said server buffer from said server to said client is required;
signaling client buffer information related to a state of said client buffer to said server; and
transmitting data packets from said server to said client with a second bit-rate, wherein said second bit-rate is at least partially determined based on said client buffer information, and wherein at least one data packet transmitted with said first bit-rate and stored in said server buffer is further stored in said server buffer when said transmitting of said data packets from said server to said client with said second bit-rate starts.

2. The method according to claim 1, wherein said at least one data packet transmitted with said first bit-rate and stored in said server buffer is stored in said server buffer for a time duration that is determined by said server based on said signaled impairment information.

3. The method according to claim 1, wherein the removal of said at least one data packet transmitted with said first bit-rate and stored in said server buffer from said server buffer depends on said signaled client buffer information.

4. The method according to claim 1, wherein said client buffer information refers to an identification of the oldest data packet stored in said client buffer.

5. The method according to claim 1, wherein said transmitting of said data packets from said server to said client is at least partially based on a Real-time Transport Protocol RTP, and wherein said signaling of said impairment information and said client buffer information is at least partially based on a Real-time Transport Control Protocol RTCP.

6. The method according to claim 1, wherein said data packets are associated with a media stream that is transmitted from said server to said client according to a 3GPP Packet-Switched Streaming Service PSS.

7. A system for improving a cooperation between a packetized data bit-rate adaptation and a data packet re-transmission, comprising:
a server; and
a client;
wherein data packets are transmitted from said server to said client with a first bit-rate; wherein at least one of said transmitted data packets is at least temporarily stored in at least one server buffer; wherein at least one of said transmitted data packets is at least temporarily stored in a client buffer; wherein impairment information related to an impairment of at least one of said transmitted data packets during said transmitting is signaled to said server; wherein said signaled impairment information is analyzed by said server to decide if a re-transmission of at least one data packet stored in said server buffer from said server to said client is required; wherein client buffer information related to a state of said client buffer is signaled to said server; wherein data packets are transmitted from said server to said client with a second bit-rate; wherein said second bit-rate is at least partially determined based on said client buffer information; and wherein at least one data packet transmitted with said first bit-rate and stored in said server buffer is further stored in said server buffer when said transmitting of said data packets from said server to said client with said second bit-rate starts.

8. A client for improving a cooperation between a packetized data bit-rate adaptation and a data packet re-transmission, comprising:
means arranged for receiving data packets transmitted from a server to said client with a first bit-rate, wherein at least one of said transmitted data packets is at least temporarily stored in at least one server buffer;
means arranged for at least temporarily storing at least one of said transmitted data packets in a client buffer;
means arranged for signaling impairment information related to an impairment of at least one of said transmitted data packets during said transmitting to said server, wherein said signaled impairment information is analyzed by said server to decide if a re-transmission of at least one data packet stored in said server buffer from said server to said client is required;
means arranged for signaling client buffer information related to a state of said client buffer to said server;
means arranged for receiving data packets transmitted from said server to said client with a second bit-rate, wherein said second bit-rate is at least partially determined based on said client buffer information, and wherein at least one data packet transmitted with said first bit-rate and stored in said server buffer is further stored in said server buffer when said transmitting of said data packets from said server to said client with said second bit-rate starts.

9. A server for improving a cooperation between a packetized data bit-rate adaptation and a data packet re-transmission, comprising:
means arranged for transmitting data packets from said server to a client with a first bit-rate, wherein at least one of said transmitted data packets is at least temporarily stored in a client buffer;
means arranged for at least temporarily storing at least one of said transmitted data packets in at least one server buffer;
means arranged for receiving signaled impairment information related to an impairment of at least one of said transmitted data packets during said transmitting, wherein said signaled impairment information is analyzed by said server to decide if a re-transmission of at least one data packet stored in said server buffer from said server to said client is required;
means arranged for receiving signaled client buffer information related to a state of said client buffer;
means arranged for transmitting data packets from said server to said client with a second bit-rate, wherein said second bit-rate is at least partially determined based on said client buffer information, and wherein at least one data packet transmitted with said first bit-rate and stored in said server buffer is further stored in said server buffer when said transmitting of said data packets from said server to said client with said second bit-rate starts.

10. A method for improving a cooperation between a packetized data bit-rate adaptation and a data packet re-transmission, comprising:
transmitting data packets from a server to a client with a first bit-rate;
at least temporarily storing at least one of said transmitted data packets in at least one server buffer;
at least temporarily storing at least one of said transmitted data packets in a client buffer;
signaling impairment information related to an impairment of at least one of said transmitted data packets during said transmitting to said server;
signaling client buffer information related to a state of said client buffer to said server, wherein said signaled client buffer information is analyzed by said server to change said first bit-rate of said transmitting of said data packets to a second bit-rate;
deciding, based on said signaled impairment information and said signaled client buffer state information, if a data packet re-transmission is required; and
only re-transmitting at least one data packet stored in said server buffer from said server to said client, if it is decided that a data packet re-transmission is required.

11. The method according to claim 10, wherein said impairment information allows to determine a sequence number of at least one data packet impaired during said transmitting, and wherein said client buffer information refers to a sequence number of the oldest data packet stored in said client buffer, and wherein said deciding if a data packet re-transmission is required depends on a difference between said sequence number of said at least one impaired data packet and said oldest data packet.

12. The method according to claim 11, wherein data packets stored in said server buffer are deleted depending on a difference between their associated sequence numbers and said sequence number of said oldest data packet.

13. The method according to claim 10, wherein said transmitting of said data packets from said server to said client is at least partially based on a Real-time Transport Protocol RTP, and wherein said signaling of said impairment information and said client buffer information is at least partially based on a Real-time Transport Control Protocol RTCP.

14. The method according to claim 10, wherein said data packets are associated with a media stream that is transmitted from said server to said client according to a 3GPP Packet-Switched Streaming Service PSS.

15. A system for improving a cooperation between a packetized data bit-rate adaptation and a data packet re-transmission, comprising:
a server; and
a client,
wherein data packets are transmitted from a server to a client with a first bit-rate; wherein at least one of said transmitted data packets is at least temporarily stored in at least one server buffer;
wherein at least one of said transmitted data packets is at least temporarily stored in a client buffer;
wherein impairment information related to an impairment of at least one of said transmitted data packets during said transmitting is signaled to said server; wherein client buffer information related to a state of said client buffer is signaled to said server; wherein said signaled client buffer information is analyzed by said server to change said first bit-rate of said transmitting of said data packets to a second bit-rate; wherein, based on said signaled impairment information and said signaled client buffer state information, it is decided if a data packet re-transmission is required; and wherein at least one data packet stored in said server buffer is only re-transmitted from said server to said client, if it is decided that a data packet re-transmission is required.

16. A client for improving a cooperation between a packetized data bit-rate adaptation and a data packet re-transmission, comprising:
means arranged for receiving data packets transmitted from a server to a client with a first bit-rate, wherein at least one of said transmitted data packets is at least temporarily stored in at least one server buffer;
means arranged for at least temporarily storing at least one of said transmitted data packets in a client buffer;
means arranged for signaling impairment information related to an impairment of at least one of said transmitted data packets during said transmitting to said server;
means arranged for signaling client buffer information related to a state of said client buffer to said server, wherein said signaled client buffer information is analyzed by said server to change said first bit-rate of said transmitting of said data packets to a second bit-rate;
means arranged for receiving at least one data packet stored in said server buffer and re-transmitted from said server to said client, wherein said at least one data packet is only re-transmitted if it is decided that a data packet re-transmission is required, and wherein said decision is based on said signaled impairment information and said signaled client buffer state information.

17. A server for improving a cooperation between a packetized data bit-rate adaptation and a data packet re-transmission, comprising:
means arranged for transmitting data packets from said server to a client with a first bit-rate, wherein at least one of said transmitted data packets is stored in a client buffer;
means arranged for at least temporarily storing at least one of said transmitted data packets in at least one server buffer;
means arranged for receiving signaled impairment information related to an impairment of at least one of said transmitted data packets during said transmitting to said server;
means arranged for receiving signaled client buffer information related to a state of said client buffer to said server, wherein said signaled client buffer information is analyzed by said server to change said first bit-rate of said transmitting of said data packets to a second bit-rate;
means arranged for deciding, based on said signaled impairment information and said signaled client buffer state information, if a data packet re-transmission is required; and
means arranged for re-transmitting at least one data packet stored in said server buffer from said server to said client, wherein said re-transmitting is only performed if it is decided that a data packet re-transmission is required.

18. A computer program with instructions operable to cause a processor to perform the method steps of claim 1.

19. A computer program product comprising a computer program with instructions operable to cause a processor to perform the method steps of claim 1.

20. A computer program with instructions operable to cause a processor to perform the method steps of claim 10.

21. A computer program product comprising a computer program with instructions operable to cause a processor to perform the method steps of claim 10.
